(19) United States
(12) Patent Application Publication
(10) Pub. No.: US 2016/0208622 A1
(43) Pub. Date: Jul. 21, 2016

(54) ARRANGEMENT OF COOLING CHANNELS IN A TURBINE BLADE

(71) Applicant: SIEMENS AKTIENGESELLSCHAFT, München (DE)

(72) Inventors: Fathi Ahmad, Kaarst (DE); Thomas Burzych, Dusseldorf (DE); Eugen Hummel, Mulheim an der Ruhr (DE); Gordon Emanuel Kunze, Neukirchen-Vluyn (DE); Frank Preuten, Voerde (DE); Thomas Alexis Schneider, Mulheim an der Ruhr (DE); Hannes Teuber, Mulheim (DE)

(73) Assignee: Siemens Aktiengesellschaft, Munich (DE)

(21) Appl. No.: 15/023,392

(22) PCT Filed: Sep. 17, 2014
(86) PCT No.: PCT/EP2014/069747

§ 371 Date: Mar. 20, 2016

(30) Foreign Application Priority Data
Sep. 25, 2013 (EP) 13185944.9

(51) Int. Cl. F01D 5/18

(52) U.S. Cl. CPC F01D 5/187; F05D 2220/32; F05D 2260/202

(57) ABSTRACT

An arrangement of a plurality of cooling channels within a turbine blade conveys cooling fluid, wherein the cooling channels lead through the turbine blade, which has a blade root, a blade tip, a leading edge, and a trailing edge, to one or more cooling-fluid outlets, wherein the cooling channels are connected to each other at selected locations and extend separately from each other in other regions in such a way that, in the event of damage to the turbine blade in the region of one cooling channel, the cooling by the other cooling channels remains largely unimpaired, wherein at least one cooling channel begins in a region near the leading edge and near the blade root and leads as a diagonal channel through the turbine blade into a region near the trailing edge and near the blade tip.

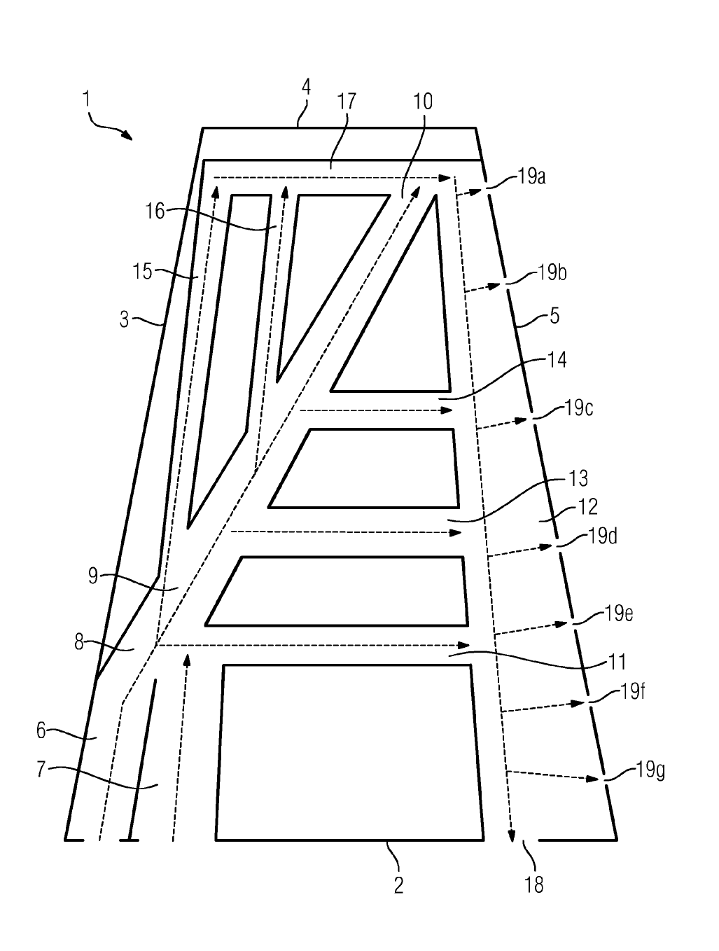

### CROSS REFERENCE TO RELATED APPLICATIONS

This application is the US National Stage of International Application No. PCT/EP2014/069747 filed Sep 17, 2014, and claims the benefit thereof. The International Application claims the benefit of European Application No. EP13185944 filed Sep 25, 2013. All of the applications are incorporated by reference herein in their entirety.

### FIELD OF INVENTION

The invention relates to an arrangement of cooling channels in a turbine blade.

### BACKGROUND OF INVENTION

Turbine blades, in particular blades of gas turbines, are highly loaded components. In operation, rotation takes place at high rotational speeds. Therefore, high mechanical strength is necessary. In addition, and especially in the case of gas turbine blades, high temperatures arise during operation. It is generally the case that higher temperatures of the gas mixture driving the turbine blades have a positive effect on the efficiency of the gas turbine. In that context, in order to prevent excessively high turbine blade temperatures, the turbine blades are cooled. To that end, cooling channels are frequently arranged inside the turbine blades.

Occasionally, the turbine blades are damaged by impacting foreign bodies. A consequence of this can be that air issues from the cooling channels and sometimes substantially impairs the cooling of the turbine blade. This frequently leads to the damaged blade having to be quickly replaced.

U.S. Pat. No. 6,382,914 B1 discloses an arrangement for distributing cooling fluid in a turbine blade. This arrangement provides for a row of cooling channels which run, in the internal space of the turbine blade, parallel to a leading edge and parallel to a trailing edge of the turbine blade. At least some of the cooling channels are connected by a diagonal channel. This is designed to improve cooling.

Further cooling devices for turbine blades are known from documents JP S59 231103 A, from FR 1 209,752 A, from GB 827 289 A and from U.S. Pat. No. 3,014,693 A.

The arrangements according to the above-mentioned documents, in particular U.S. Pat. No. 6,382,914 B1, might, in a certain manner, contribute to it being possible, to a certain extent, to maintain cooling in the event of damage to the turbine blade and thus by implication to a cooling channel. This is not specified in the documents and can in fact only be recognized in light of the invention described below.

### SUMMARY OF INVENTION

The invention has an object of further improving cooling in the event of damage to a cooling channel.

This object is achieved with the independent claim. Advantageous configurations can be found in the subclaims.

What is proposed is an arrangement of multiple cooling channels, that is to say at least two cooling channels, within a turbine blade, for conveying cooling fluid. The cooling fluid is generally air.

The cooling channels lead through the turbine blade to one or more cooling fluid outlets.

To that end, the turbine blade generally has a blade root, a blade airfoil tip, a leading edge and a trailing edge.

In that context, the cooling channels are connected to one another at specific points and run separate from one another in other regions such that, in the event of damage to the turbine blade in the region of one cooling channel, the cooling through the other cooling channels remains largely unimpaired.

In the prior art, it is generally the case that a cooling channel runs from the blade root to the blade airfoil tip along the leading edge. A leak due to damage in this cooling channel results in cooling fluid issuing at that location. This is problematic since it interrupts cooling in those regions lying downstream of the leak.

It is however particularly problematic if the cooling fluid from this cooling channel is designed to meander further through the turbine blade and provide cooling. In the event of a leak, the cooling of the turbine blade then fails substantially.

This problem can be reduced with the concept presented above, according to which the cooling channels are connected to one another at specific points and are separated from one another in other regions. By virtue of the connections at specific points, cooling fluid can pass from one cooling channel into another cooling channel. If a leak were to arise in the other cooling channel upstream of the connection, the cooling downstream would fail without the connection. The connection makes it possible for the cooling downstream of the connection to be largely maintained. However, it is also necessary to separate the cooling channels from one another in other regions. Without the separation, in the event of a leak cooling fluid could flow unhindered to the leak, such that cooling would again be more markedly impaired. Above all, however, it is also necessary during normal operation, that is to say when there is no leak, to have a channel structure, i.e. also a separation of the cooling channels, in order to actually guide the cooling fluid through the entire turbine blade. Otherwise, the cooling fluid would flow along a short path from a cooling fluid inlet to a cooling fluid outlet. Therefore, it is always necessary to strike an acceptable balance between connections between the cooling channels and separated regions. Taking into account the above explanations, a person skilled in the art will be able to arrive at a large number of different arrangements.

In that context, an important aspect is that at least one cooling channel begins in a region close to the leading edge and close to the blade root and runs as a diagonal channel through the turbine blade into a region close to the trailing edge and close to the blade airfoil tip. That being said, it is important to clarify that the diagonal channel need not necessarily start at the blade root or at the leading edge, but merely in that region.

However, a beginning at the blade root and at the leading edge should not be excluded. The same holds for the end of the diagonal channel close to the trailing edge and close to the blade airfoil tip. The diagonal channel makes it possible to easily guide the cooling fluid into various regions of the turbine blade and to ensure efficient cooling everywhere.

Even the arrangement described above cannot avoid cooling being impaired, or even failing in individual regions, in the event of a leak. Overall, however, the loss of cooling fluid is substantially reduced and in the intact blade region cooling is largely ensured. Thus, the mechanical stability and the strength remain largely unimpaired. This allows continued operation of the damaged turbine blade.

Further, two cooling channels begin at the blade root, in a region close to the leading edge, and end in a region close to the blade root, where they are connected to one another and to the diagonal channel. This allows cooling fluid to pass from cooling fluid inlets at the blade root to the diagonal channel. If cooling fluid were to issue from one of the above-mentioned cooling channels because of a leak, the diagonal channel can still be supplied with cooling fluid through the other cooling channel.

In addition, other cooling channels branch off from the diagonal channel, wherein in particular cooling channels branch off in the direction of the trailing edge and cooling channels branch off in the direction of the blade airfoil tip. It is thus possible to further optimize the distribution of the cooling fluid in the entire region of the turbine blade.

Moreover, the cooling channels branching off in the direction of the trailing edge run essentially perpendicular to the trailing edge. In addition to this, the cooling channels running in the direction of the blade airfoil tip run essentially parallel to the trailing edge. This also serves to further optimize the distribution of the cooling fluid. The purpose of this is always that a leak at one location should impair the cooling of the turbine blade as little as possible. Even should it remain necessary in the long-term to replace the turbine blade, it is a great advantage if this can wait until the next scheduled major service of the turbine. Often, the raised temperature does not lead immediately to damage to the turbine blade which is no longer acceptable, but only after longer operation at excess heat.

Although the representation has been chosen primarily with regard to the cooling of rotor blades, which are attached by means of the blade root to a rotor, the envisaged cooling concept can also in principle be used for guide vanes.

In one embodiment of the invention, it is provided that the cooling channels are connected to one another such that, when the arrangement is flowed through, cooling fluid flows regularly from one cooling channel into another cooling channel. It would however also be conceivable to provide this only in the event of a leak. For the purpose of efficient throughflow, it has proven expedient to provide this also during normal operation.

In one embodiment of the invention, the cooling channels are separated from an internal wall of the turbine blade by means of a perforated plate or a device in the manner of a perforated plate, such that the cooling fluid can arrive at the internal wall of the turbine blade essentially perpendicular to the latter. This achieves what is referred to as impingement cooling. This is efficient since the cooling fluid becomes turbulent at the internal wall and flows away again once heated. If the cooling fluid were simply to flow past the internal wall of the turbine blade, it would be possible for a film of relatively weak flow to form immediately adjacent to the wall. In addition, cooling fluid that had just been heated in one region would be used to cool other regions.

In one embodiment of the invention, at least one cooling channel begins at the blade root, in a region close to the leading edge of the turbine blade. As is also the case in the arrangements known from the prior art, the inlet for the cooling fluid is generally, for structural reasons, at the blade root. Since the gas mixture driving the turbine blade is hottest at the leading edge, it is here that the thermal load on the turbine blade is highest. It is therefore expedient for a cooling channel to begin in the region of the leading edge.

In a further embodiment of the invention, a cooling channel, into which open the above-mentioned cooling channels running in the direction of the blade airfoil tip, runs parallel to the blade airfoil tip. The cooling channel running parallel to the blade airfoil tip can in that context open into the same region as the diagonal channel.

In a further embodiment of the invention, cooling fluid outlets, through which cooling fluid can pass from the region within the turbine blade into a region outside the turbine blade, are present in the region of the trailing edge. It is thus possible to achieve further cooling of an external wall in the region of the trailing edge. The cooling fluid which has exited can optionally be used to drive a further turbine stage.

In a further embodiment of the invention, at least one cooling fluid outlet is present at the blade root, in the region of the trailing edge. The cooling fluid can flow from the cooling fluid inlet, which is normally at the blade root in the region of the leading edge, through the turbine blade and flow back to the blade root in the region of the trailing edge. The exiting cooling fluid can be reused for cooling other turbine blades.

### BRIEF DESCRIPTION OF THE DRAWINGS

The sole FIGURE shows, schematically, an arrangement of cooling channels, according to an embodiment of the invention.

### DETAILED DESCRIPTION OF INVENTION

What is shown is an arrangement 1 of cooling channels in a gas turbine blade. Although the chosen view shows, for the sake of clarity, essentially only the cooling channels, nonetheless the geometry of the turbine blade will be presented first in order to be able to better explain the course of the cooling channels.

At the bottom is a blade root 2, by means of which the turbine blade is attached to a rotor. A leading edge 3 is shown on the left. The leading edge 3 is the region which first encounters a gas mixture driving the turbine blade. A blade airfoil tip 4 is shown at the top. A trailing edge 5 is arranged on the right. The turbine blade is not planar but curved. In that context, the leading edge 3 and the trailing edge 5 can be straight but can also be curved. The blade root 2 and the blade airfoil tip, by contrast, are always curved, as is the remaining blade region. The curvature is due to an aerodynamic shape of the turbine blade.

The turbine blade has a front wall (not shown) which runs from the leading edge to the trailing edge, and a rear wall which runs at a distance from the front wall and which once again leads from the trailing edge to the leading edge. In general, the distance between the front wall and the rear wall is very small in the region of the leading edge 3 and of the trailing edge 5, and increases toward the middle of the blade.

Now the arrangement of the cooling channels. A first cooling channel 6 begins at the blade root 2 and runs directly along the leading edge 3. On that side of the cooling channel 6 oriented away from the leading edge 3, a further cooling channel 7, which is separated from the cooling channel 6, runs away from the blade root 2. The cooling channels 6 and 7 open into a region 8 which is located close to the leading edge 3 and close to the blade root 2. There, the cooling channels 6 and 7 are connected to one another. Furthermore, a diagonal channel 9, which leads to a region 10 close to the trailing edge 5 and close to the blade airfoil tip 4, begins in the region 8. From the region 8, a cooling channel 11 runs parallel to the blade root 2. The cooling channel 11 opens into a cooling channel 12 running parallel to the trailing edge 5. Following the diagonal channel 9 from the region 8 close to the leading edge 3 to the region 10 close to the trailing edge 5, two cooling channels 13 and 14 branch off and run parallel to the cooling channel 11 and open into the cooling channel 12.

Furthermore, two cooling channels 15 and 16, running parallel to the leading edge 3, branch off from the diagonal channel 9. These open into a cooling channel 17 which runs parallel to the blade airfoil tip 4 in the vicinity of the blade airfoil tip 4 and opens into the region 10, where it connects with the diagonal channel 9. Moreover, the region 10 connects with the cooling channel 12 running along the trailing edge 5. The cooling channel 12 opens into the blade root 2 in a cooling fluid outlet 18. Moreover, cooling fluid outlets 19a to 19g are present at the trailing edge 5.

The arrangement 1 of the cooling channels 6, 7, 9, 11, 12, 13, 14, 15, 16, 17 can, as is apparent, also be termed “fir-tree design”.

The direction of flow in normal operation, that is to say during cooling without a leak, is indicated by arrows. It is clear that a leak in one of the many cooling channels would usually limit cooling but not entirely interrupt cooling.

Although the invention has been described and illustrated in more detail by way of the preferred exemplary embodiment, the invention is not restricted by the disclosed examples and other variations can be derived herefrom by a person skilled in the art without departing from the scope of protection of the invention.

1.-10. (canceled)

11. An arrangement for conveying cooling fluid, comprising:
multiple cooling channels (6, 7, 9, 11, 12, 13, 14, 15, 16, 17) within a turbine blade,
wherein the cooling channels (6, 7, 9, 11, 12, 13, 14, 15, 16, 17) lead through the turbine blade, which has a blade root, a blade airfoil tip, a leading edge and a trailing edge, to one or more cooling fluid outlets,
wherein the cooling channels (6, 7, 9, 11, 12, 13, 14, 15, 16, 17) are connected to one another at specific points and run separate from one another in other regions such that, in the event of damage to the turbine blade in the region of one cooling channel (6, 7, 9, 11, 12, 13, 14, 15, 16, 17), the cooling through the other cooling channels (6, 7, 9, 11, 12, 13, 14, 15, 16, 17) remains largely unimpaired,
wherein at least one cooling channel begins in a region close to the leading edge and close to the blade root and runs as a diagonal channel (9) through the turbine blade into a region close to the trailing edge and close to the blade airfoil tip,
wherein two cooling channels (6, 7) begin at the blade root, in a region close to the leading edge, and end in a region close to the blade root, and are connected to one another and to the diagonal channel (9), and
wherein other cooling channels (11, 13, 14) branch off from the diagonal channel (9) in the direction of the trailing edge and cooling channels (15, 16) branch off in the direction of the blade airfoil tip, and
wherein the cooling channels (11, 13, 14) branching off in the direction of the trailing edge run essentially perpendicular to the trailing edge and/or the cooling channels (15, 16) running in the direction of the blade airfoil tip run essentially parallel to the trailing edge.

12. The arrangement as claimed in claim 11,
wherein the cooling channels (6, 7, 9, 11, 12, 13, 14, 15, 16, 17) are connected to one another such that, when the arrangement is flowed through, cooling fluid flows regularly from one of the cooling channels (6, 7, 9, 11, 12, 13, 14, 15, 16, 17) into another of the cooling channels (6, 7, 9, 11, 12, 13, 14, 15, 16, 17).

13. The arrangement as claimed in claim 11,
wherein the cooling channels (6, 7, 9, 11, 12, 13, 14, 15, 16, 17) are separated from an internal wall of the turbine blade by means of a perforated plate or a device in the manner of a perforated plate, such that the cooling fluid can arrive at the internal wall of the turbine blade essentially perpendicular to the latter.

14. The arrangement as claimed in claim 11,
wherein at least one of the cooling channels (6, 7, 9, 11, 12, 13, 14, 15, 16, 17) begins at the blade root, in a region close to the leading edge.

15. The arrangement as claimed in claim 14,
wherein a cooling channel, into which open the cooling channels (15, 16) running in the direction of the blade airfoil tip, runs parallel to the blade airfoil tip.

16. The arrangement as claimed in claim 11,
wherein cooling fluid outlets, at which cooling fluid can pass from the region within the turbine blade into a region outside the turbine blade, are present in the region of the trailing edge.

17. The arrangement as claimed in claim 11,
wherein at least one cooling fluid outlet is present at the blade root, in the region of the trailing edge.
